(19) United States
(12) Patent Application Publication
(10) Pub. No.: US 2017/0073014 A1
(43) Pub. Date: Mar. 16, 2017

(54) Energy Transferring Apparatus of a Vehicle

(71) Applicant: Ford Global Technologies, LLC, Dearborn, MI (US)

(72) Inventors: Jamil M. ALWAN, Ann Arbor, MI (US); Jayanth Kumar BASAVALINGIAH, West Bloomfield, MI (US); Matthew B. MAKOWSKI, Northville, MI (US)

(21) Appl. No.: 14/851,796

(22) Filed: Sep. 11, 2015

(51) Int. Cl. B62D 21/15; B62D 25/08

(52) U.S. Cl. CPC B62D 21/155; B62D 25/082

(57) ABSTRACT

A collision energy absorbing assembly for a land vehicle includes first and second frame rails and a powertrain having an engine and a transmission. The powertrain is disposed between the rails such that the powertrain is spaced apart from the rails. The vehicle also includes an energy-transfer element attached to an inner side of the first rail or powertrain to reduce a spacing between the powertrain and first rail thereby increasing a cross-car load transfer during a collision.

### TECHNICAL FIELD

The present disclosure relates to an energy-transferring apparatus for a vehicle that transfers impact energy from a chassis to the powertrain when the vehicle is involved in a small offset rigid barrier frontal collision.

### BACKGROUND

Land vehicles are tested for crashworthiness by a variety of tests including frontal impacts, side impacts, rear impacts, roll-over, and other tests. Previous, frontal impact tests specified that a vehicle impacts a barrier between the frame rails that extend longitudinally relative to the vehicle. In this type of test, the frame rails provided the primary support for the vehicle body. Crush cans located between a front bumper and the frame rails absorb part of the force of the frontal impact to the front bumper. Structures that interfere with compressing crush cans may create problems in achieving successful test results in frontal impact crash tests. The extent of any intrusions into the passenger compartment are measured at the lower hinge pillar, footrest, left toe pan, brake pedal, parking brake pedal, rocker panel, steering column, upper hinge pillar upper dash and left instrument panel.

An Insurance Institute for Highway Safety (IIHS) Small Offset Rigid Barrier (SORB) test simulates small overlap frontal crashes against a rigid barrier. In the proposed test, the vehicle impacts a rigid barrier having a six inch pole-like radius on one corner with a 25% overlap at 40 miles per hour (MPH). The impact is outboard of the frame rails and the frame rails provide minimum resistance to intrusion into the passenger compartment.

### SUMMARY

According to one embodiment, a vehicle includes a pair of rails, and a powertrain disposed between the rails. The powertrain includes an engine, and a transmission that has a surface facing a side of one of the rails and spaced apart from the side. An energy-transfer element is attached to the surface and is disposed between the surface and side to reduce a spacing between the surface and side thereby increasing a cross-car load transfer during a collision.

According to another embodiment, a vehicle includes a pair of rails, and a powertrain disposed between the rails such that the powertrain is spaced apart from the rails. The vehicle also includes an energy-transfer element attached to an inner side of one of the rails and extending towards the powertrain to reduce a spacing between the powertrain and inner side thereby increasing a cross-car load transfer during a collision.

According to yet another embodiment, a collision energy absorbing assembly for a land vehicle includes first and second frame rails and a powertrain having an engine and a transmission. The powertrain is disposed between the rails such that the powertrain is spaced apart from the rails. The vehicle also includes an energy-transfer element attached to an inner side of the first rail or powertrain to reduce a spacing between the powertrain and first rail thereby increasing a cross-car load transfer during a collision.

### BRIEF DESCRIPTION OF THE DRAWINGS

FIG. 1 illustrates a perspective view of a front end of a vehicle.

FIG. 2 illustrates a plan view of a front end of a vehicle according to one embodiment.

FIG. 3 illustrates a diagrammatic front cross-sectional view of FIG. 2.

FIG. 4 illustrates a plan view of a front end of a vehicle according to another embodiment.

FIG. 5 illustrates a diagrammatic plan view of a front end of a vehicle without an energy-transfer element during a SORB test.

FIG. 6 illustrates a diagrammatic plan view of a front end of a vehicle just prior to impact with a SORB.

FIG. 7 illustrates a diagrammatic plan view of a front end of a vehicle during late stages of an impact with a SORB.

FIG. 8 illustrates a plan view of a front and of the vehicle according to yet another embodiment.

FIG. 9 illustrates a diagrammatic plan view of the vehicle of FIG. 8 during a SORB test.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

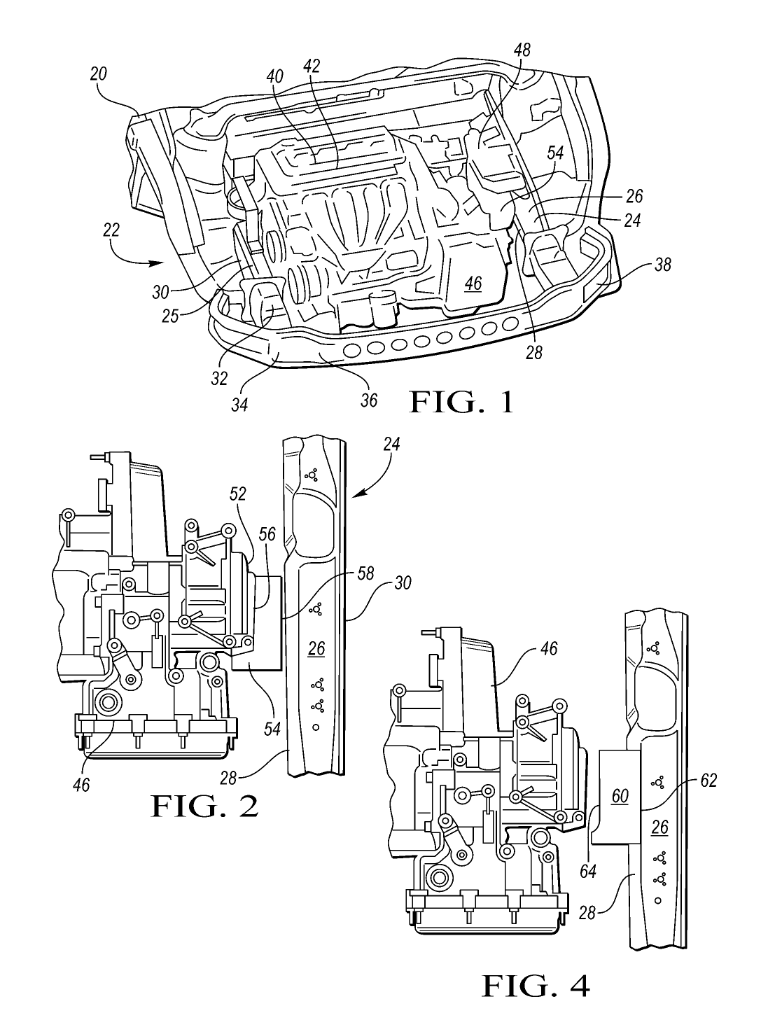

Referring to FIG. 1, a front end 22 of a vehicle 20 is illustrated. The illustrated example vehicle 20 is a front-wheel-drive car, however, the present disclosure contemplates other types of vehicles such as crossovers, sport-utility vehicles, and trucks. The vehicle 20 includes a chassis 24 having a pair of spaced apart frame rails 25 and 26. Each of the frame rails 25, 26 extend longitudinally along at least a portion of the vehicle 20. Each of the frame rails 25, 26 includes an inner side 28 and an outer side 30. Each of the frame rails is connected to a bumper assembly 34 via a crush can 32. The crush cans 32 are designed to deform during a collision to dissipate energy and lessen the impact force on the vehicle and passengers. The bumper assembly 34 includes a center beam 36 that is connected to each of the crush cans and deflectors 38 that extend outwardly from each end of the center beam 36.

A powertrain 40, in this example, is transversely mounted between the frame rails 25, 26. The powertrain includes an engine 42 and a transmission 46. The engine 42 includes one or more engine mounts connecting the engine 42 to the chassis 24, and the transmission 46 includes one or more transmission mounts 48 connecting the transmission 46 to the chassis 24. For example, one of the transmission mounts may be connected to the rail 26 and to the top of one end of the transmission. The transmission 46 includes a proximal end that is coupled to the engine 42 and a distal end that faces the inner side 28 of the frame rail 26. The distal end and the inner side 28 of the frame rail 26 are spaced apart defining gap. An energy-transfer element 54 is disposed within the gap between the distal end and the inner side 28 of the frame rail 26. The energy-transfer element 54 may be attached to the distal end or the frame rail 26. The energy-transfer element 54 fills a majority of the gap creating a smaller space between the distal end and the inner side 28 of the frame rail 26. While the energy-transfer element 54 fills a portion of the gap, the energy-transfer element is only rigidly attached to one of the powertrain 40 and the frame rail 26 because relative movement between the powertrain 40 and the chassis 24 is beneficial.

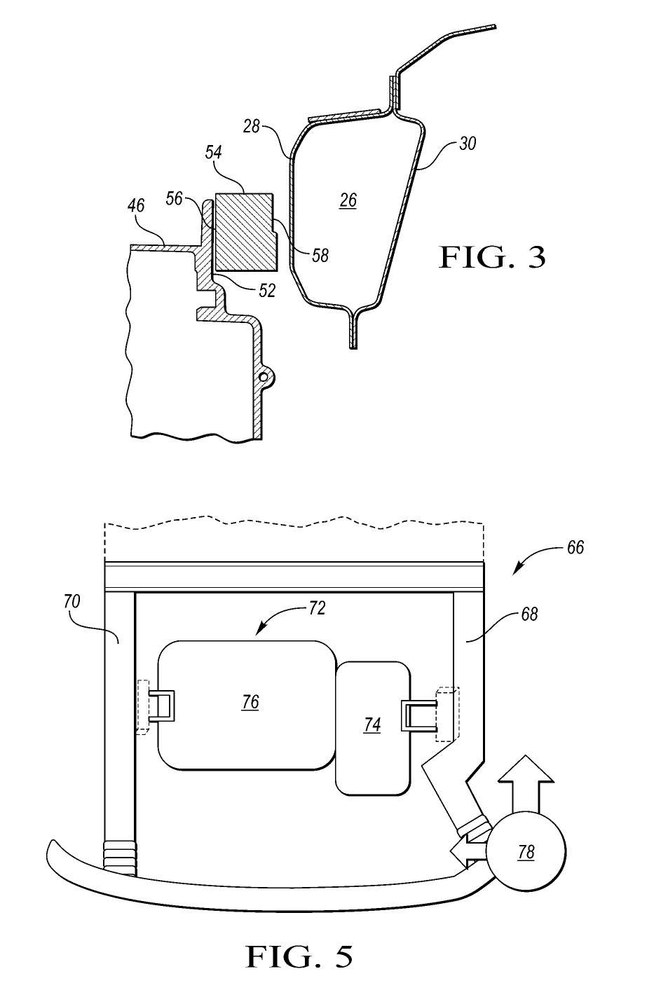

FIGS. 2 and 3 illustrate an embodiment where the energy transfer-element 54 is attached to the transmission 46. The energy-transfer element 54 is a rigid body that is designed to minimally deform during an impact so that the impact energy is transferred from the rail into the powertrain. The energy-transfer element 54 may be a block of metal, plastic, composite or other material suitable to handle impact loads experienced during a SORB-type collision. The energy-transfer element 54 may be a solid block, such as cast-iron or cast aluminum. Alternatively, the energy-transfer element 54 may have a hollow center defined by outer walls. Here, the energy-transfer element may be formed of a stamped material, such as steel panels welded together at the edges. The stamped material may be corrugated to increase strength. The energy-transfer element 54 may also include cross ribs to increase strength. The energy-transfer element 54 may be attached to the transmission 46 via any means known in the art—such as welding, mechanical fasteners, adhesive, etc.

The energy-transfer element 54 may include a first side 56 that is attached to the distal end 52 of the transmission 46, and a second side 58 that faces the inner side 28 of the frame rail 26. The energy-transfer element 54 may have any shape that is suitable to fit between the gap created between the transmission 46 and the frame rail 26. For example, the energy-transfer element 54 may be a rectangular prism. Alternatively, the energy-transfer element 54 may be shaped to conform with the outer surface of the transmission 46. In the illustrated embodiment, the energy transfer element 54 is L-shaped. It may be preferable to shape the energy-transfer element 54 to conform with the shape of the transmission 46.

FIG. 4 illustrates an embodiment where an energy-transfer element 60 is attached to the inner side 28 of the frame rail 26. The transfer element 60 includes a first side 62 that is attached to the inner side 28 via any means known in the art, and a second side 64 that faces the transmission 46.

FIG. 5 illustrates a vehicle 66 that does not include an energy-transfer element. The vehicle includes a pair of frame rails 68, 70 and a powertrain 72 disposed between the frame rails. The powertrain 72 includes a transmission 74 and an engine 76. FIG. 5 illustrates a snapshot of the vehicle during a SORB test after the vehicle 66 has collided with the barrier 78. The collision with the barrier 78 has caused the driver-side frame rail 68 to buckle inwardly towards the powertrain 72. However, the designed spacing (i.e. spacing prior to a collision) between the transmission 74 and the inside surface of the frame rail 68 is great enough that even after buckling of the side rail 68, the side rail 68 does not engage the transmission 74. Because of this, the powertrain 72 creates less cross-car load transfer than a vehicle equipped with the energy-transfer element of the present disclosure. This reduced cross-car load transfer, reduces lateral movement of the vehicle 66 away from the barrier 78 during a collision. In vehicles equipped with the energy-transfer element, the designed spacing between the powertrain and the side rail is reduced due to the inclusion of the energy-transfer element. Thus, the side rail contacts the powertrain when it buckles during a SORB-type collision. This increases the cross-car load transfer and urges the vehicle away from the barrier (or other object) to reduce the impact.

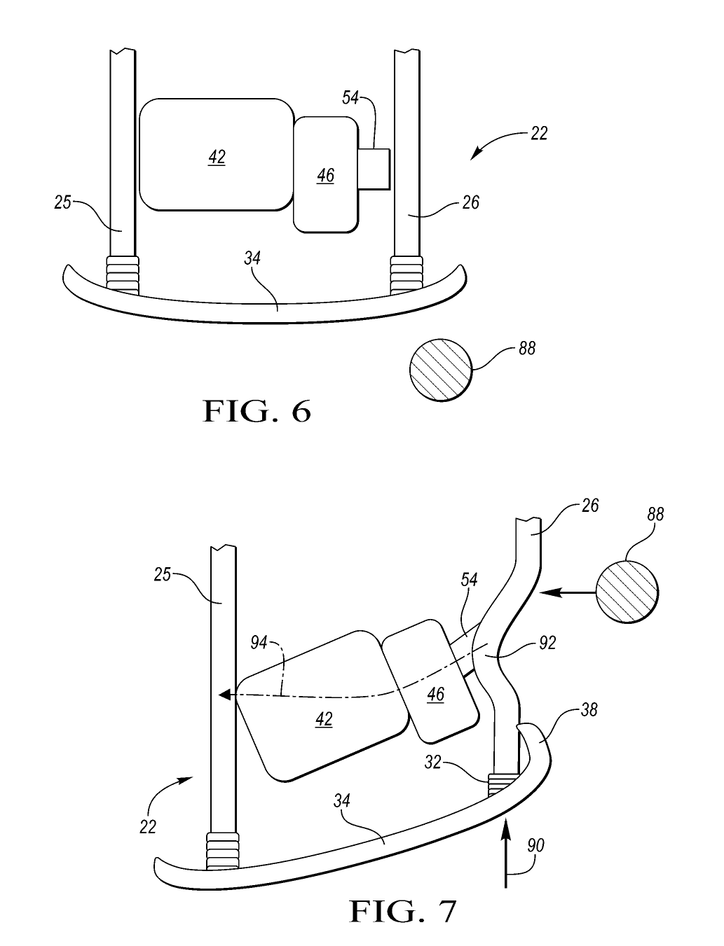

Referring to FIGS. 6 and 7, a series of views of the front end structure 22 of the vehicle 20 are shown during the course of a collision with a SORB. During the SORB test, a barrier 88 will impact the bumper assembly 34 outside the rail 26 at approximately 40 MPH. A portion of the impact energy travels into the frame rail 26 along load path 90 causing the crush can 32 to buckle. The deflector 38 is compressed into the frame rail 26 causing a portion 92 of the frame rail 26 to deflect inwardly. The inward deflection of the frame rail 26 engages with the energy-transfer element 54 and transfers a portion of the impact into the powertrain 40 along load path 94. The load path 94 first travels through the energy-transfer element 54, into the transmission 46, through the engine 42, and finally into the other frame rail 25. This creates a cross-car load transfer that provides lateral movement of the vehicle causing the vehicle 20 to glance off the barrier: reducing impact forces on the passenger cabin. The inclusion of the energy-transfer element 54 places the transmission 46 and the frame rail 26 in closer proximity to one another. This causes the transmission 46 and the rail 26 to engage sooner and with greater force, which increases the cross-car load transfer as compared to vehicles without an energy-transfer element.

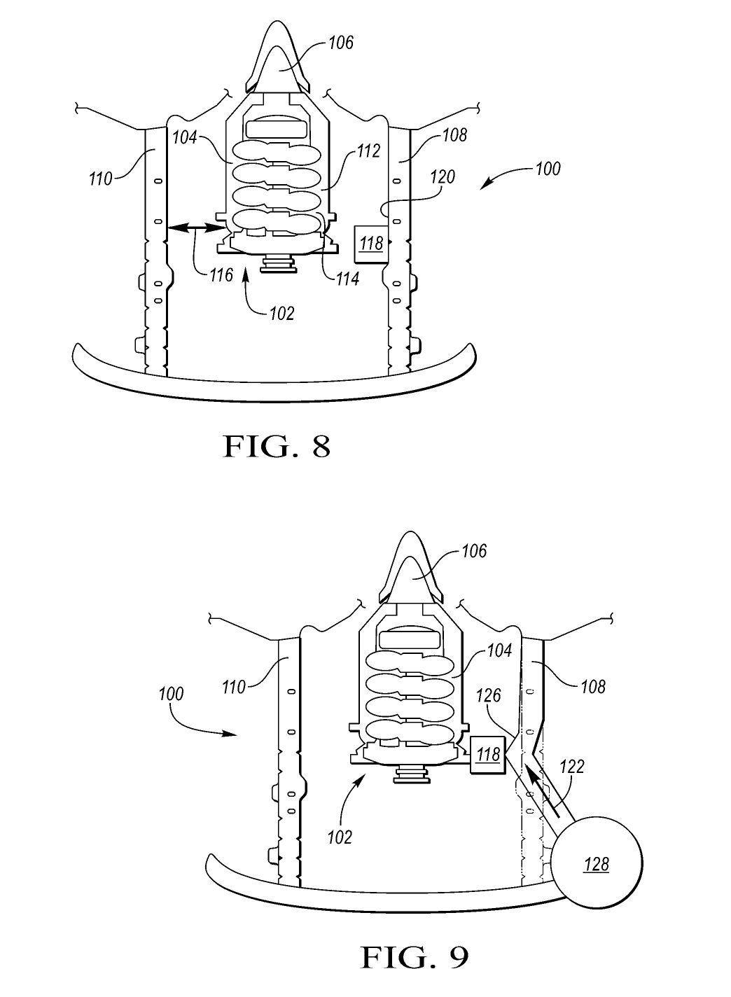

FIG. 8 illustrates another vehicle 100 having a longitudinally mounted powertrain 102 that includes an engine 104 and transmission 106. The vehicle 100 includes a pair of spaced apart frame rails 108, 110. The powertrain 102 is disposed between the frame rails 108, 110. The engine 104 includes an engine block 112 and cylinder heads 114 connected to the block at an upper side. The engine 104 sits between the frame rails 108, 110 such that the outer sidewalls of the block 112 are spaced apart from an inner side of a corresponding frame rail. The gap 116 is typically wide enough that the frame rails do not engage the engine 104 during a SORB-type collision.

An energy-transfer element 118 may be disposed between the engine 104 and one of the frame rails 108, 110. The energy-transfer element 118 may be connected to the inner side 120 of the frame rail or may be connected to the engine 104, such as at the engine block 112. The vehicle 100 may include a first energy transfer element 118 disposed between the driver-side rail 108 and the engine 104. In some embodiments, a second energy-transfer element (not shown) is disposed between the passenger-side rail 110 and the engine 104.

FIG. 9 illustrates a snapshot of the vehicle 100 during a SORB test. During the test, the vehicle 100 collides with the barrier 128. A first load path 122 extends from the barrier 128 into and along the frame rail 108. This causes a portion 126 of the frame rail 108 to buckle towards the engine 104. Vehicle 100 includes an energy-transfer element 118, which allows the frame rail 108 to engage with the engine 104. A portion of the impact from the collision transfers from the frame rail 108 to the engine 104 via the energy transfer element 118. This creates a cross car load transfer that provides lateral movement of the vehicle 100 causing the vehicle to glance off of the barrier 128: reducing impact forces on the passenger cabin.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A vehicle comprising:
a pair of rails;
a transmission disposed between the rails and defining a surface facing a side of one of the rails and spaced apart from the side; and
an energy-transfer element attached to the surface and disposed between the surface and side to reduce a spacing between the surface and side thereby increasing a cross-car load transfer during a collision, wherein the energy-transfer element and the transmission are separate components.

2. The vehicle of claim 1 wherein the powertrain transmission is transversely mounted between the rails.

3. The vehicle of claim 1 wherein the energy-transfer element and the transmission are formed of different materials.

4. The vehicle of claim 1 further including a transmission mount connecting the transmission to one of the rails.

5. The vehicle of claim 1 wherein the energy-transfer element further includes a first side disposed against the surface and a second side facing the side of one of the rails.

6. The vehicle of claim 5 wherein the energy-transfer element is attached to the surface by one of: fasteners, welds, or adhesive.

7. A vehicle comprising:
a pair of rails;
a powertrain disposed between the rails such that the powertrain is spaced apart from the rails, the powertrain including an engine having an outer surface facing a corresponding one of the rails; and
an energy-transfer element attached to the engine with a first side disposed against the outer surface and a second side extending towards the corresponding one of the rails to reduce a spacing between the powertrain and inner side thereby increasing a cross-car load transfer during a collision.

8. The vehicle of claim 7 wherein the energy-transfer element has a rigid body, and the rigid body and the engine are separate components.

9. The vehicle of claim 7 wherein the energy-transfer element is mounted to the outer surface by one of: fasteners, welds, or adhesive.

10. The vehicle of claim 7 wherein a load path for a frontal impact travels into one of the rails, to the powertrain via the energy-transfer element, and into the other of the rails creating lateral movement of the vehicle causing the vehicle to glance off of a small offset rigid barrier.

11. (canceled)

12. The vehicle of claim 7 wherein the energy-transfer element is a solid body.

13. A collision energy absorbing assembly for a land vehicle comprising:
first and second frame rails;
a powertrain disposed between the frame rails and including an engine and a transmission, wherein one of the engine and the transmission define a first outer surface that faces the first rail; and
an energy-transfer element including a rigid body having a second outer surface and a third outer surface on opposing sides of the rigid body, wherein the rigid body is attached to the first outer surface such that the second outer surface is disposed against the first outer surface and the third outer surface is adjacent to the first rail to reduce a spacing between the powertrain and first rail thereby increasing a cross-car load transfer during a collision.

14. The assembly of claim 13 wherein the powertrain is transversely mounted between the frame rails, the transmission defines the first outer surface, and the energy-transfer element is attached to the transmission.

15. The assembly of claim 14 wherein the energy-transfer element is formed of a different type of material than the engine and the transmission.

16. (canceled)

17. The assembly of claim 13 wherein the powertrain is longitudinally mounted, the engine defines the first outer surface, and the energy-transfer element is attached to the engine between a side of a block of the engine and the first frame rail.

18. (canceled)

19. The assembly of claim 13 wherein a load path for a frontal impact travels into the first frame rail, to the powertrain via the energy-transfer element, and into the second frame rail creating lateral movement of the vehicle causing the vehicle to glance off of a small offset rigid barrier.

20. The assembly of claim 13 wherein the energy-transfer element is a solid metal body.
